(19) United States
(12) Patent Application Publication
(10) Pub. No.: US 2024/0402478 A1
(43) Pub. Date: Dec. 5, 2024

(54) TELESCOPE AND SPACECRAFT SYSTEM

(71) Applicant: CANON DENSHI KABUSHIKI KAISHA, Chichibu-shi (JP)

(72) Inventors: Satoshi Kozu, Tokyo (JP); Yuta Mameshiro, Fujimi-shi (JP); Shunsuke Kuwaki, Tokyo (JP); Kotaku Sato, Kawaguchi-shi (JP)

(21) Appl. No.: 18/672,196

(22) Filed: May 23, 2024

(30) Foreign Application Priority Data
May 29, 2023 (JP) 2023-088025

(51) Int. Cl. G02B 23/04; B64G 1/10; G01J 9/00; G02B 7/183; G02B 23/16

(52) U.S. Cl. CPC G02B 23/04; B64G 1/1028; G02B 7/183; G02B 23/16; G01J 2009/002

(57) ABSTRACT

A telescope includes a light beam splitting device disposed on an optical axis of the telescope, the light beam splitting device including a plurality of mirror surfaces configured to split a beam of light incident on the telescope into a plurality of beams of light; and a mounting device configured to mount a plurality of optical detectors to the telescope such that the plurality of optical detectors respectively correspond to the plurality of beams of light split by the light beam splitting device.

### CROSS-REFERENCE TO RELATED APPLICATION

This application claims priority to and the benefit of Japanese Patent Application No. 2023-088025 filed on May 29, 2023, the entire disclosure of which is incorporated herein by reference.

### BACKGROUND OF THE INVENTION

### Field of the Invention

The present invention relates to a telescope for installation in a spacecraft.

### Description of the Related Art

Conventionally, space telescopes are installed on spacecraft systems such as artificial satellites to observe Earth from outer space. In particular, artificial satellites on which a space telescope is installed are called optical satellites.

Unlike conventional large artificial satellites, in recent years, super-small (masses of 10-100 kg) to small (masses of 100-500 kg) artificial satellites are being developed across the world. Transport rockets are launched more frequently than before, and over 100 artificial satellites are shot up to space annually.

In this way, with the increasing miniaturization of optical satellites to small and super-small sizes, space telescopes for installation on these satellites are required to not only deliver excellent optical performance but also have qualities other than optical performance, such as lightness in weight, low-cost, and compactness.

A space telescope is composed of an optical system and a detector (camera). Many known space telescopes installed aboard super-small and small optical satellites have optical system apertures of about 80-300 mm. However, in order to capture images of Earth at higher resolution, it is known that the optical system apertures need to be further enlarged, such as to about 300 mm to 700 mm.

Normally, a telescope with an optical system aperture exceeding 100 mm uses an optical system comprised of a plurality of mirrors that is called a reflecting telescope. That is because the configuration using refractors results in a heavier weight and a longer lens tube, whereas a reflecting telescope can be made lightweight and compact. In a reflecting telescope, which is composed of a plurality of mirrors, the first mirror has the largest aperture and is called the primary mirror to define the aperture of the optical system. Even if the diameter of the primary mirror is enlarged, the same degree of precision is required for the mirror surface, and thus the manufacture of primary mirrors with large diameters of about 300 mm to 700 mm is technically challenging. Moreover, even if this technical challenge is overcome to successfully manufacture large-diameter primary mirrors with high precision, temperature change in turn causes changes in the shape of the mirror surface of the primary mirror, and the degree of change increases with the diameter. As the shape of the mirror surface of the primary mirror changes, the imaging position changes, thus causing focal displacement.

As the aperture of the optical system is increased, it is also possible to increase the image circle diameter, which indicates the diameter of the imaging plane of the optical system. For example, in a space telescope with an aperture of 300 mm to 700 mm, it is possible to obtain an image circle diameter of about 50 mm to 100 mm. In the detector for capturing images, an imaging device, such as an area sensor or a line sensor, is disposed in the location of the image circle. Therefore, if it is possible to have a large image circle diameter, it is preferable to enlarge the area of the imaging device to effectively use the field of view obtained by the telescope.

However, an imaging device is often selected from those of fixed sizes by considering the pixel size, the configuration of the optical filters, and the cost among other factors. Therefore, it is difficult to freely set the area of the imaging device to match the image circle diameter of the telescope. For example, if the image circle diameter is large (i.e., the area of the image surface is large) and the area of the imaging device is small, the imaging device may not fully cover the field of view imaged by the optical system. In this case, a plurality of imaging devices could be arranged to make effective use of the image circle diameter. However, as the substrates of the imaging devices would interfere, it is difficult to arrange a plurality of imaging devices on a single imaging surface without creating gaps between the devices.

To address this problem, for example, International Publication No. 2014/093769 discloses a configuration in which two imaging devices are disposed in different spatial locations by arranging mirrors in the optical path of a telescope to split the optical path.

According to the configuration described in International Publication No. 2014/093769, however, as each optical element is fixedly disposed, as described above, focal displacement may occur if the shape of the primary mirror changes due to a temperature change in the primary mirror.

### SUMMARY OF THE INVENTION

The present invention has been made in view of the foregoing problem, and it is an object of the present invention to provide a telescope capable of effectively using the image circle diameter and favorably correcting focal displacement that results from a change in the shape of the primary mirror.

According to a first aspect of the present invention, there is provided a telescope comprising: a light beam splitting device disposed on an optical axis of the telescope, the light beam splitting device including a plurality of mirror surfaces configured to split a beam of light incident on the telescope into a plurality of beams of light; and a mounting device configured to mount a plurality of optical detectors to the telescope such that the plurality of optical detectors respectively correspond to the plurality of beams of light split by the light beam splitting device.

According a second aspect of the present invention, there is provided a spacecraft system comprising: the telescope described above; and a controller configured to control a direction of image capturing performed by the telescope.

### BRIEF DESCRIPTION OF THE DRAWINGS

FIG. 1 is a perspective view showing the configuration of a telescope according to one embodiment of the present invention.

FIG. 2 is a cross-sectional view of an optical system of the telescope.

FIG. 3 is a cross-sectional view showing a detector system attached to the telescope.

FIG. 4 is a view showing the shape of an optical element.

FIG. 5 is a view of the detector system as seen from a direction perpendicular to an optical axis.

FIG. 6 is a cross-sectional view showing the configuration of the detector system.

FIG. 7 is a cross-sectional view showing the optical element and a focusing actuator.

FIG. 8 is a block diagram showing the configuration of a focusing driving unit.

FIGS. 9A to 9C are views that describe the focusing of a first detector.

FIGS. 10A to 10C are views that describe the focusing of the first detector and a fourth detector.

FIG. 11A to 11C are views showing a variant of the embodiment.

FIG. 12 is a view showing how a beam of light is split.

FIG. 13 is a view showing an artificial satellite on which the telescope is installed.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

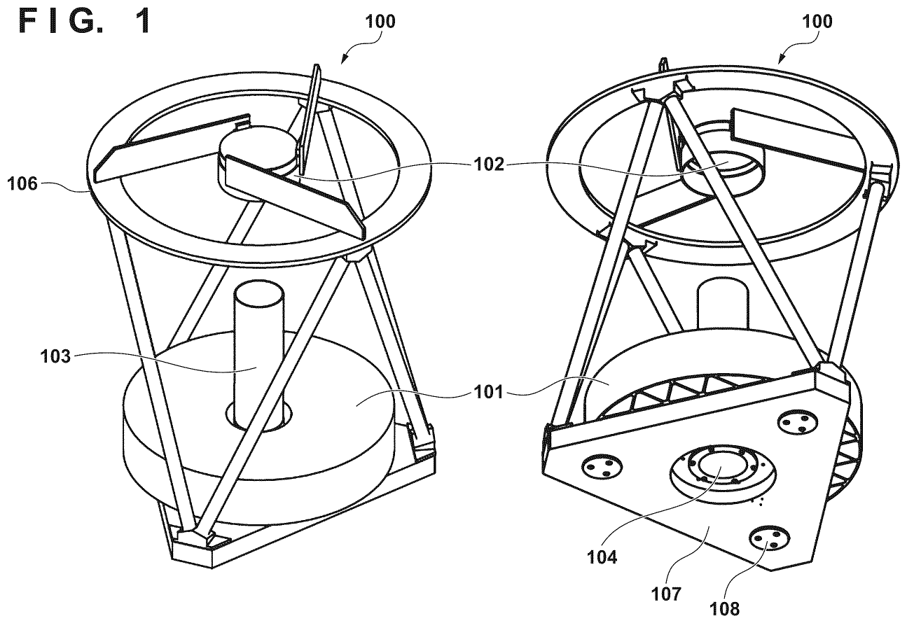

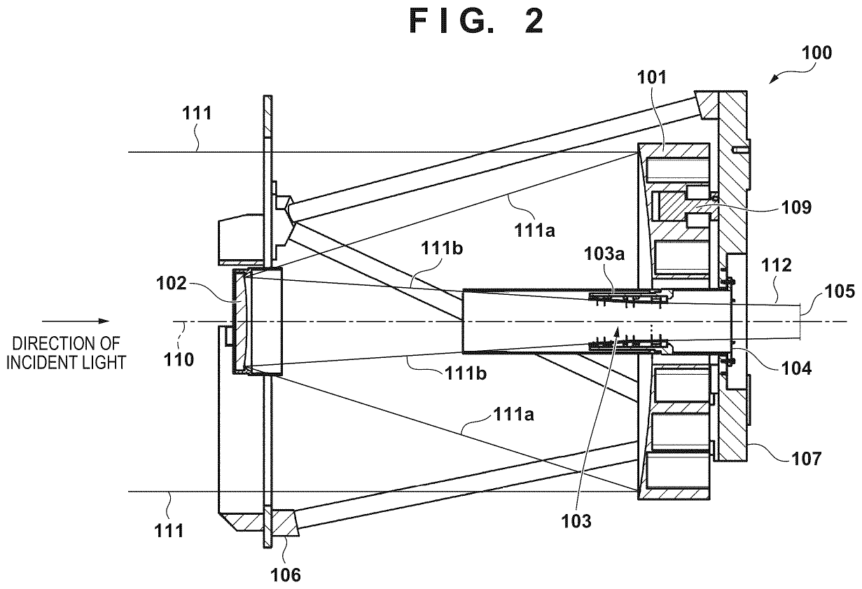

FIG. 1 is a perspective view showing the configuration of a telescope 100 according to one embodiment of the present invention. Additionally, FIG. 2 is a cross-sectional view of the optical system of the telescope 100.

The telescope 100 shown in FIGS. 1 and 2 is a reflecting telescope and includes a primary mirror 101 composed of a concave mirror and a secondary mirror 102 composed of a convex mirror, which are disposed to oppose each other along an optical axis 110. The primary mirror 101 is supported by an optical bench 107 via primary mirror fasteners 109, and the secondary mirror 102 is supported by a secondary mirror support member 106 composed of a plurality of components so as to be spaced apart from the primary mirror 101 by a predetermined distance along the optical axis 110. It should be noted that as the primary mirror 101 and the secondary mirror 102 alone would not provide a good image with a sufficiently small aberration across the entire imaging plane, a lens 103 for correcting the aberration is disposed on the optical path of the light reflected by the secondary mirror 102. The lens 103 includes three to seven refractive lenses fixed to the optical bench 107 via a lens tube 103a.

The primary mirror 101, the secondary mirror 102, and the lens 103 are arranged around the optical axis 110 such that the optical system comprised of these elements forms an object image on an imaging plane 105. The beam of light from the object is incident on the telescope 100 from the left as indicated by an arrow as the direction of incident light in FIG. 2. That is, when the telescope 100 is used as a space telescope to observe Earth, Earth is located to the left of FIG. 2.

The light incident on the telescope 100 in the direction of incident light in FIG. 2 passes along an optical path 111 and is reflected by the primary mirror 101 as indicated by an optical path 111a. Upon passing along the optical path 111a, the light is further reflected by the secondary mirror 102 and travels along an optical path 111b, and is focused via the lens 103 onto the imaging plane 105 as a beam of light 112. A camera mount 104 is disposed on the optical bench 107 so that detectors (cameras) can be installed on the imaging plane 105 at positions equivalent to the position of the imaging plane (the equivalent positions will be further described below).

Zero thermal expansion glass-ceramics or heat-resistant glass is often used as the material for the primary mirror 101 and the secondary mirror 102. There are cases in which the mirror surfaces may be coated with aluminum, silver, or gold according to the wave ranges used. There are cases in which radiation resistant optical glass is used for the lenses. The transmittance may deteriorate at about 400 nm in ordinary optical glass due to cosmic radiation (i.e., browning), in which case radiation-resistant optical glass is used to suppress this phenomenon. In addition, the telescope 100 is desirably not susceptible to temperature changes and needs to be capable of withstanding the vibration and shock of launching. To that end, aluminum, stainless steel (SUS), carbon fiber reinforced plastic (CFRP), or zero thermal expansion ceramics is used as the material for the support members of the primary mirror 101 and secondary mirror 102.

The telescope 100 configured as described above is fixed to an artificial satellite via mechanical fasteners 108 provided in the optical bench 107, and is used to capture images of the surface of Earth.

It should be noted that, as explained in the BACKGROUND OF THE INVENTION, compared to refracting telescopes, which are composed solely of refractive lenses, reflecting telescopes are more suitable for use in artificial satellites as their overall lengths (the distance from the secondary mirror to the imaging plane) can be shortened and their weights can be reduced. For this reason, reflex optical systems are often used in telescopes that require large apertures, for example, of 300 mm or larger.

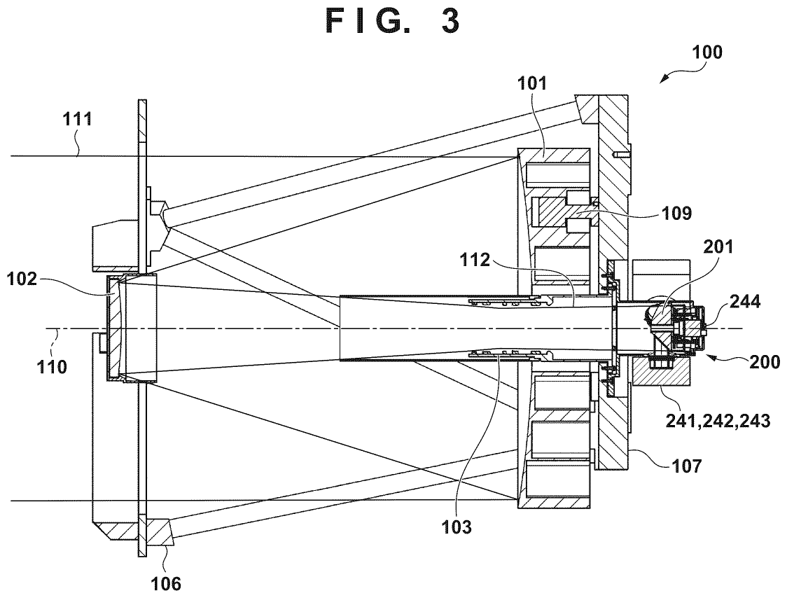

FIG. 3 is a cross-sectional view showing that a detector system 200 (a plurality of cameras) is attached to the telescope 100.

The detector system 200 is attached to the optical system of the telescope 100 via the camera mount (mounting means) 104. As described in detail below, upon passing through the lens 103, the beam of light 112 is split into three directions at 120-degree intervals along a circumference around the optical axis 110 by an optical element (light beam splitting means) 201 disposed on the optical axis 110. The three split beams of light cause object images to be formed at three positions equivalent to the above-described imaging plane 105. To capture these three object images, the detector system (optical detector system) 200 has a first detector (first camera) 241, a second detector (second camera) 242, and a third detector (third camera) 243 disposed so as to surround the optical axis 110 at 120-degree intervals. Furthermore, a fourth detector (fourth camera) 244 is also disposed rearward (on the right in the figure) of the optical element 201 on the optical axis 110 to capture an image of the object formed by the beam of light passing through a through-hole 214 provided at the center of the optical element 201. It should be noted that the first to fourth detectors 241 to 244 each have disposed thereon an imaging device composed of, for example, a CMOS sensor.

The internal structure and function of the detector system 200 will be described in detail below.

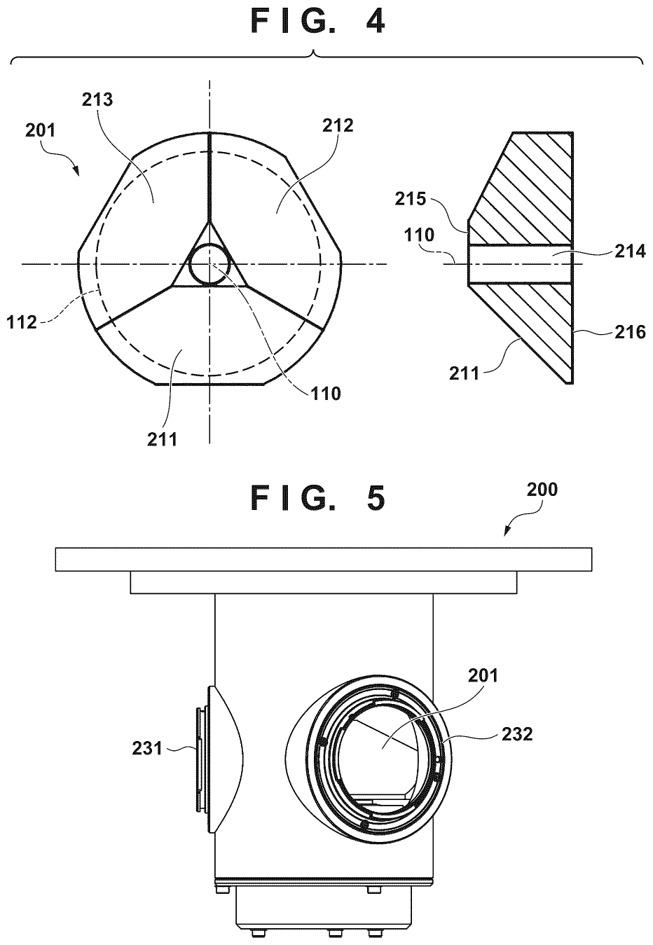

FIG. 4 is a view that shows the shape of the optical element 201.

In FIG. 4, the optical element 201 includes three mirror surfaces 211, 212, and 213 split at 120-degree intervals around the optical axis 110. Each of the mirror surfaces 211, 212, and 213 is formed to be inclined at 45 degrees with respect to the optical axis, and the optical element 201 has a general shape of a triangular pyramid. The three mirror surfaces 211, 212, and 213 split the beam of light 112 passing through the lens 103 into three directions at 120-degree intervals around the optical axis 110. Three circumferentially split images of the field of view of the telescope 100 can be obtained by capturing the three split-up beams of light with the first to third detectors 241 to 243.

The size of the optical element 201 is set to sufficiently cover the beam of light 112 in the vicinity of the imaging plane in FIG. 2. The optical element 201 further includes a through-hole 214 centered at the apex of the three mirror surfaces 211, 212, and 213 to allow the beam of light passing through the through-hole 214 to be captured by the above-described fourth detector 244. Additionally, flat surfaces 215 and 216 perpendicular to the optical axis are formed at the two ends of the optical element 201 along the optical axis. The flat surfaces 215 and 216 perpendicular to the optical axis are preferably chosen not to be mirror surfaces, but rather are given anti-reflective treatment to prevent unnecessary reflection. It should be noted that the optical element 201 is made of any of quartz, general optical glass, aluminum and other metals, whereas the mirror surfaces 211, 212, and 213 are coated with aluminum, silver, gold, or other materials according to the wave ranges used. This embodiment is described assuming that silver coating is applied to quartz.

It should be noted that although the optical element 201 has been described above as splitting the beam of light into three parts at 120-degree intervals around the optical axis 110, the number of split parts is not limited to three; the beam may be split into two or four or more parts. Moreover, although the mirror surfaces 211, 212, and 213 have been described to be inclined at 45 degrees with respect to the optical axis, they may have an inclination other than 45 degrees.

FIG. 5 is a view of the detector system 200 as seen from a direction perpendicular to the optical axis 110. As the mirror surfaces 211, 212, and 213 are formed on the optical element 201 at 120-degree intervals as described above, the detector system 200 has camera mounts 231, 232, and 233 (the mount 233 not shown) for mounting the first to third detectors 241 to 243 provided around the optical axis 110 at 120-degree intervals in the same phase as the mirror surfaces 211, 212, and 213. In this embodiment, so-called digital single lens cameras are used for the detectors. Therefore, the same type of mounts as those on interchangeable lens for digital single lens cameras are used as the camera mounts 231 to 233. Many digital single lens cameras use a fastening method called the bayonet type, and this embodiment also employs this type of mounts.

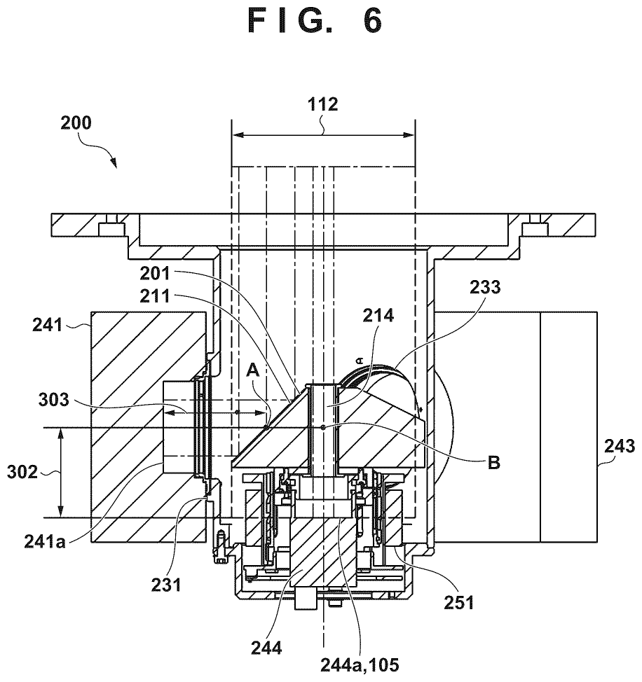

FIG. 6 is a cross-sectional view showing the configuration of the detector system 200. This cross-sectional view shows a cross-section of the detector system 200 taken along a plane perpendicular to one of the mirror surfaces of the optical element 201, i.e., the mirror surface 211.

In FIG. 6, the first detector 241 is attached to the camera mount 231 such that the light perpendicularly reflected on the mirror surface 211 of the optical element 201 is incident on the first detector 241. Moreover, the light passing through the through-hole 214 in the optical element 201 is subsequently incident on the fourth detector 244 provided on the optical axis 110.

In this configuration, a distance 303 between a point A at which the beam of light 112 is reflected on the mirror surface 211 and an image capture surface 241a of the first detector 241 is set to be equal to a distance 302 between a point B on the optical axis 110 that corresponds to the point A and an image capture surface 244a (the imaging plane 105) of the fourth detector 244. The positional relationship between the image capture surface 244a of the fourth detector 244 and the image capture surfaces of the second detector 242 and the third detector 243 is set in a similar manner. According to this configuration, the image capture surfaces of the first to fourth detector 241 to 244 are located at positions equivalent to the imaging plane 105 so that an in-focus image of the subject is formed on each of the detectors.

Due to the above-described configuration, in the detector system 200, the beam of light 112 passing through the lens 103 is reflected on the optical element 201 in three directions so that these beams of light and the single beam of light passing through the optical element 201 form a total of four images of the object. In other words, the detector system 200 has four imaging planes.

Furthermore, as described in detail below, a focusing actuator 251 is disposed on the detector system 200 to focus the beams of light on the image capture surfaces of the first to fourth detector 241 to 244. The focusing actuator 251 performs focusing by moving the optical element 201 and the fourth detector 244 along the optical axis 110. The operating principle of the focusing actuator 251 will be described below.

In this embodiment, a ring-type piezoelectric actuator (ultrasonic motor) is used as the focusing actuator 251. Ring-type piezoelectric actuators are effective in outer space due to their low power consumption as friction between the rotor and the stator bring them to a stop in an unpowered state, and due to the absence of play in a weightless state. It should be noted that, in interchangeable lenses for digital cameras, ring-type piezoelectric actuators are commonly used as the drive system for the focusing lens. Although a case has been described in which a ring-type piezoelectric actuator is used as the focusing actuator, the present invention is not limited to this. Rather, a hollow motor or a stepping motor may also be used.

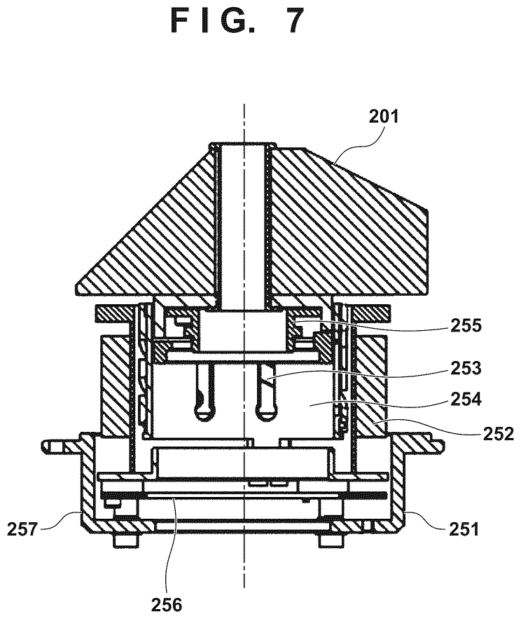

FIG. 7 is a cross-sectional view showing the optical element 201 and the focusing actuator 251.

The focusing actuator 251 includes a piezoelectric driving member 252, a rotor (cam ring) 253, a stator 254, a movable member 255, a driver substrate 256, and a support member 257. The piezoelectric driving member 252 is of a hollow type that rotates around the optical axis 110. The rotor 253 is rotated as it engages with a rotary portion provided in the piezoelectric driving member 252. The rotor 253 is formed as a cam ring with a cam groove. The movable member 255 includes three rollers phase-shifted at 120-degrees that are in engagement with the rotor 253 and the stator 254. The rotation of the rotor 253 causes the movable member 255 to move along the optical axis 110, also integrally moving the optical element 201 fixed to the movable member 255 and the fourth detector 244. It should be noted that the fourth detector 244 is comprised of a wavefront sensor. Additionally, the piezoelectric driving member 252 is driven by the driver substrate 256, and its lead amount and position are detected. In this embodiment, the amount of movement of the movable member 255 along the optical axis 110 is about 1 mm. The angle of the cam groove in the cam ring is small to provide stable operation as a torque, and the operation is stable with respect to the vibration and impact of launching of an artificial satellite.

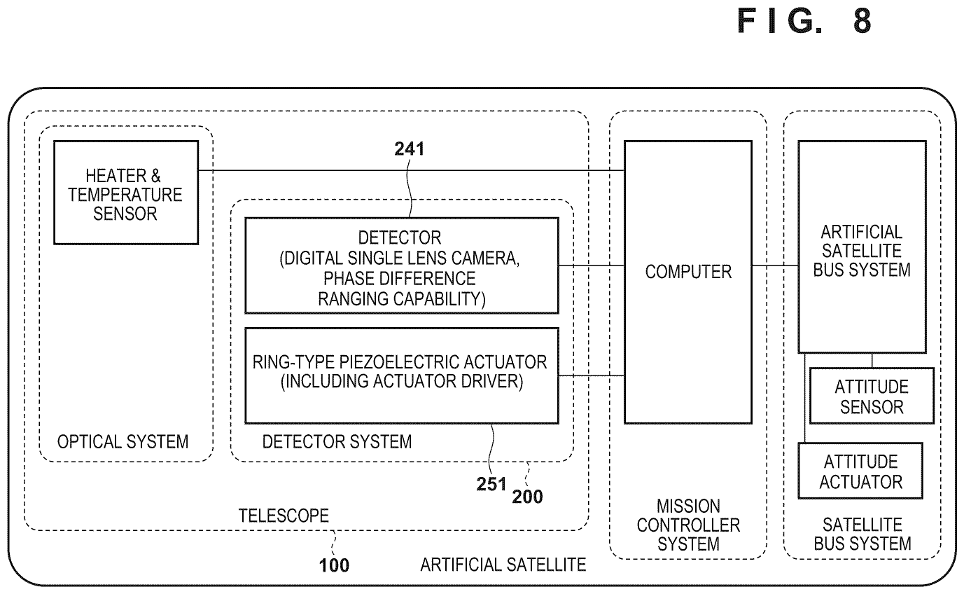

FIG. 8 is a block diagram showing the configuration of a focusing driving unit according to this embodiment.

In this embodiment, a digital single lens camera is used as the first detector 241. The CMOS sensor of the digital single lens camera has the ability to detect a phase difference, and the main body of the camera has the ability to calculate the amount of focal displacement from the phase difference. The digital single lens camera is capable of notifying a mission controller-type computer of the calculated amount of focal displacement in response to a request from the computer, which, based on the amount of focal displacement, issues instructions to the driver substrate 256 regarding the amount of movement to be made by the optical element 201. The driver substrate 256 then drives the focusing actuator to move the optical element 201. The first to fourth detectors 241 to 244 are brought to focus in this way. It should be noted that the computer is also capable of switching and controlling the temperature of a heater based on information from a temperature sensor installed on the optical system.

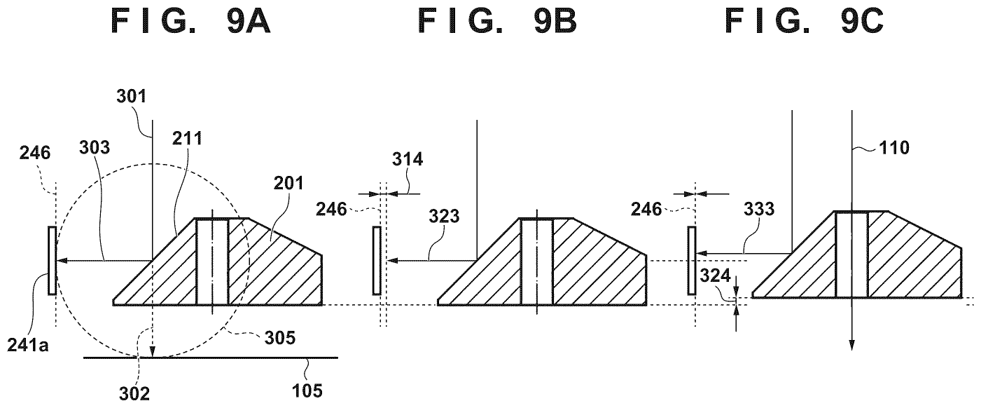

FIGS. 9A to 9C are views that illustrate the focusing of the first detector 241.

FIG. 9A shows that the focus is on the image capture surface 241a of the CMOS sensor of the first detector 241. FIG. 9B is a view showing a focal displacement resulting from thermal expansion or contraction of the primary mirror 101, the secondary mirror support member 106, the optical bench 107, etc., of the telescope 100. FIG. 9C is a view showing that the focal displacement has been corrected by moving the optical element 201.

In the condition shown in FIG. 9B, the imaging plane is displaced forward from the image capture surface 241a of the CMOS sensor of the first detector 241 by an amount of focal displacement 314. In contrast, in FIG. 9C, the optical element 201 is moved toward the primary mirror 101 along the optical axis 110 by an amount of shifting 324. In this case, the focal displacement can be corrected since the mirror surface 211 of the optical element 201 is translated by moving the optical element 201 along the optical axis 110 to change the point at which light is reflected so that the optical path length from the reflection point to the image capture surface 241a can be corrected. That is, focusing can be performed by moving the optical element 201 along the optical axis. In this embodiment, the capability of the first detector 241 to detect focal displacement based on a phase difference and the capability of the mission controller-type computer enable the calculation of the amount of movement of the optical element 201 to correct the focal displacement.

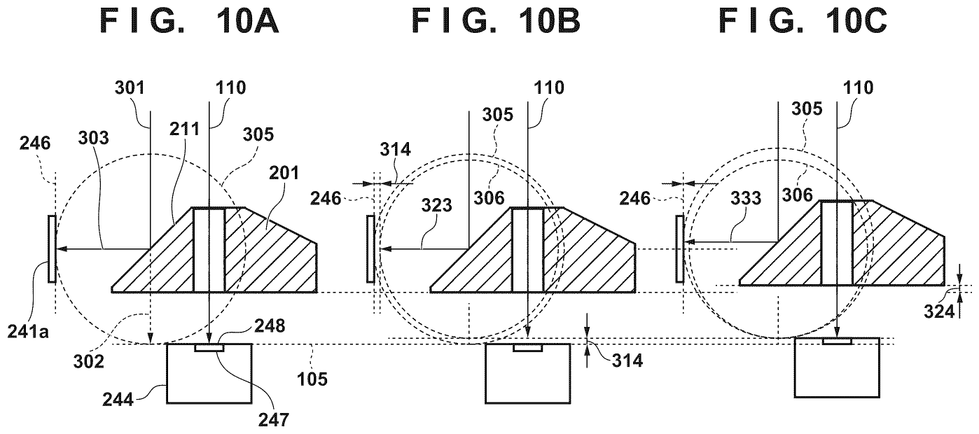

FIGS. 10A to 10C are views that describe the focusing of the first detector 241 and the fourth detector 244.

FIG. 10A shows that the focus is on the image capture surface 241a of the CMOS sensor of the first detector 241. FIG. 10B is a view showing a focal displacement resulting from thermal expansion or contraction of the primary mirror 101, the secondary mirror support member 106, the optical bench 107, etc., of the telescope 100. FIG. 10C is a view showing that the focal displacement has been corrected by moving the optical element 201 and the fourth detector 244.

In the condition shown in FIG. 10B, the imaging plane is displaced forward from the image capture surface 241a of the CMOS sensor of the first detector 241 by the amount of focal displacement 314. In this case, the focus is also displaced from the fourth detector 244 by the amount of focal displacement 314.

In contrast, in FIG. 10C, the optical element 201 and the fourth detector 244 are moved toward the primary mirror 101 along the optical axis 110 by an amount of shifting 324. In this case, the focal displacement can be corrected since the mirror surface 211 of the optical element 201 is translated by moving the optical element 201 along the optical axis 110 to change the point at which light is reflected so that the optical path length from the reflection point to the image capture surface 241a can be corrected. Moreover, as the fourth detector 244 is moved by the same amount of movement as that of the optical element 201, the focal displacement of the fourth detector 244 can simultaneously be corrected.

That is, focusing can be performed by moving the optical element 201 and the fourth detector 244 along the optical axis. In this embodiment, the capability of the first detector 241 to detect focal displacement based on a phase difference and the capability of the mission controller-type computer enable the calculation of the amount of movement of the optical element 201 to correct focal displacement.

In the above, the correction of focal displacement of the first detector 241 and the fourth detector 244 has been described, and the main cause of the focal displacement is thermal expansion and contraction of the primary mirror 101. Due to the symmetry about the optical axis 110, the focal displacement of the second and third detectors 242 and 243 coincides with that of the first and fourth detectors 241 and 244. Therefore, simply by moving the optical element 201 and the fourth detector 244 by the amount of movement required to correct the focal displacement of the first detector 241, the focal displacement of all of the first to fourth detectors 241 to 244 can also be corrected.

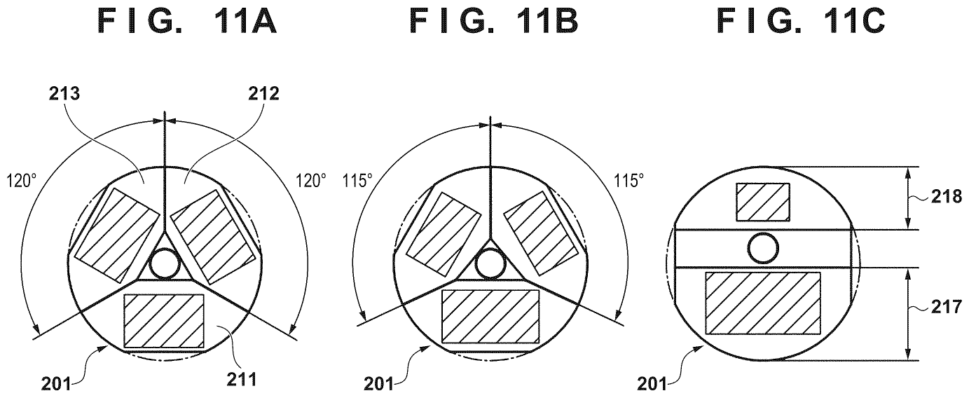

FIG. 11A to 11C are views showing a variation of the foregoing embodiment.

Although the mirror surfaces of the optical element 201 are symmetrically arranged around the optical axis and in the same phase in the foregoing embodiment, as shown in I 11A, 11B, and 11C, the mirror surfaces of the optical element 201 may be asymmetrically arranged around the optical axis by not disposing the mirror surfaces in the same phase in the rotational direction around the optical axis (i.e., by not being distributed equiangularly) or decentering the ridges or the apex from the center of the optical path. Moreover, the sizes of split mirrors may be changed according to the sizes of the imaging devices used. The arrangement shown in FIG. 11C facilitates placement of an imaging device of a large sensor size.

FIG. 12 is a view showing how a beam of light is actually split in the optical element 201.

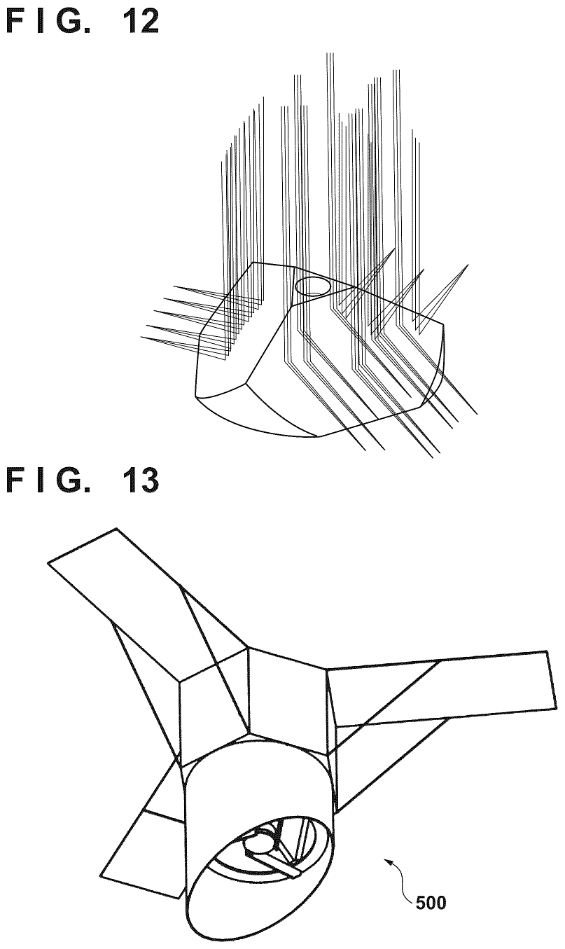

FIG. 13 is a view showing an artificial satellite on which the telescope 100 according to the present embodiment is installed. The attitude sensor and the attitude actuator shown in FIG. 8 are used in the artificial satellite bus to perform control to capture images of target ground.

As described above, according to the foregoing embodiment, it is possible to realize a telescope capable of effectively using the image circle diameter and correcting focus displacement that results from a change in the shape of the primary mirror.

The invention is not limited to the foregoing embodiments, and various variations/changes are possible within the spirit of the invention.

What is claimed is:

1. A telescope comprising:
a light beam splitting device disposed on an optical axis of the telescope, the light beam splitting device including a plurality of mirror surfaces configured to split a beam of light incident on the telescope into a plurality of beams of light; and
a mounting device configured to mount a plurality of optical detectors to the telescope such that the plurality of optical detectors respectively correspond to the plurality of beams of light split by the light beam splitting device.

2. The telescope according to claim 1, wherein the light beam splitting device is a single optical element that includes the plurality of mirror surfaces.

3. The telescope according to claim 1, wherein the mirror surfaces are inclined at 45 degrees with respect to the optical axis.

4. The telescope according to claim 1, wherein the light beam splitting device includes a through-hole in a location that corresponds to the optical axis of the telescope.

5. The telescope according to claim 4, further comprising a focusing device configured to perform focusing of the plurality of optical detectors concurrently by moving the light beam splitting device along the optical axis.

6. The telescope according to claim 5, further comprising a second optical detector disposed on an imaging plane of a beam of light passing through the through-hole.

7. The telescope according to claim 6, wherein the second optical detector is moved by the focusing device in the same direction and by the same amount as the light beam splitting device.

8. The telescope according to claim 5, wherein the focusing device includes a hollow motor.

9. The telescope according to claim 5, wherein the focusing device includes an ultrasonic motor or a stepping motor.

10. The telescope according to claim 5, wherein an amount of movement of the light beam splitting device for the focusing is calculated by a circuit included in at least one of the plurality of optical detectors and configured to detect focal displacement based on a phase difference.

11. The telescope according to claim 6, wherein the second optical detector is a wavefront sensor.

12. The telescope according to claim 1, wherein the mounting device includes a bayonet-type mount.

13. The telescope according to claim 1, wherein the plurality of mirror surfaces are asymmetrically arranged around the optical axis.

14. The telescope according to claim 1, wherein no mirror surface is formed on a plane perpendicular to the optical axis of the light beam splitting device.

15. A spacecraft system comprising:
the telescope according to claim 1; and
a controller configured to control a direction of image capturing performed by the telescope.
